(19) United States
(12) Patent Application Publication
(10) Pub. No.: US 2013/0088137 A1
(43) Pub. Date: Apr. 11, 2013

(54) LED LAMP SYSTEM

(71) Applicant: Hendrik Edgarius Anthonie Heins, BB Almere (NL)

(72) Inventor: Hendrik Edgarius Anthonie Heins, BB Almere (NL)

(21) Appl. No.: 13/383,444

(22) PCT Filed: May 12, 2010
(86) PCT No.: PCT/NL10/50276

§ 371 Date: Dec. 19, 2012

(30) Foreign Application Priority Data
May 12, 2009 (NL) 2002876

(51) Int. Cl. F21V 29/00; H05B 33/02

(52) U.S. Cl. CPC F21V 29/004; H05B 33/02
USPC 313/46

(57) ABSTRACT

The invention relates to a led lamp system with a led lamp, with at least one led and terminals for electricity supply of the led, wherein the led is attached to a holder with electrical connections, wherein the led lamp system further comprises a fitting, and fitting and holder can detachably be attach to each other, wherein the fitting comprises electrical connections for receiving electricity supply suited for the led, that in attached condition cooperate with the terminals at the holder wherein he holder is arranged for heat conduction and arranged for transport of heat from led to an external surface of the holder.

The invention relates to a led lamp system with a led lamp, with at least one led and connected to the at least one led connections for the supply of electricity to the led.

Led lighting combines an exceptionally long life (provided not too high voltage is applied) with a high output. That is why many lighting armatures are being fitted with leds. In relation to existing lighting leds have completely different properties with respect to certain issues. The led is small and although the heat emission is less than that of usual lighting, certainly with higher Powers this heat, has to be dissipated properly not to let the temperature of the led increase to too high values, because of its small size. Further it is important that the supply of energy to the leds is well controlled, both polarity as voltage are important factors. With a wrong polarity the led does not function at all and a too high voltage and/or current reduce the life drastically.

In the armatures for led lighting that are currently available on the market, at a certain position in the armature a transformer is being incorporated, that transforms the voltage of the net to a low voltage supply, if so desired with the required current that is fit for the one or more leds that are placed elsewhere in the armature. In the destined positions in the armature the leds are being built in, in a fixed way. This however has a number of disadvantages. Leds are being manufactured in different executions with respect to both power as colour temperature. When a user has purchased a certain armature and has installed this at a position of use, then it is quite well possible that the amount of light does not live up to the expectations. There can be too much light but also less than was expected. It is also possible that the kind of light does not comply with the expectations. The light can be to white or possibly it has also too soft a colour. However, because of the fact that the leds have been built-in fixed in the armatures the leds can only be replaced by a professional or the complete armature has to be replaced. This is undesirable for a user. Further the supplier of the armature must produce armatures with different leds and keep these in stock.

The German Gebrauchsmuster DE 299 15 140 U1 describes a led lamp that can be screwed or introduced in a fitting, wherein the lamp may or may not be provided with electronic components for the energy supply of the led lamp. Although a led lamp according to DE 299 15 140 U1 is both exchangeable and can be suitable for use in armatures that have already been equipped with a transformer and possibly also a rectifier, such a lamp can be improved considerably.

Also led lamps are offered for replacement of existing lighting, but with these the specific advantages that leds have to offer, such as small dimensions, are not being utilized. Also the life of these led lamps for replacement of existing lighting is considerably lower than with led lamps lighting that is specifically arranged for the purpose.

The specific advantages for led lighting and notably an optimal life can be reached with a led lamp system according to claim 1. An exchangeable led lamp with an appropriate fitting is made available, that can be connected to a suitable electricity supply for the led lamp such as a low voltage supply for direct current of the required voltage or current, and because of the good heat conduction away from the led, the led can be operated under optimal conditions of amount of resulting light and life.

Although the led in relation to other light sources uses little power and the proportion of this power that is transferred to heat is also small, the small surface area of a led can quickly lead to high temperatures. It is therefore a special advantage that the holder is executed with good heat conductor properties for transporting the heat away from the led to the external surface of the holder. Because the external surface of the holder is much larger than that of the led, the same holds for the cooling properties. Because of this the led can operate at a lower operating temperature, which increases the life drastically.

In a advantageous embodiment the holder is mainly thick walled, which has a positive effect on both the heat capacity as the heat transport, and is preferably largely of a material with good heat conductive properties such as aluminium. Because aluminium is also a good conductor for electricity, care has to be taken that there is a good electrical insulation between the holder and the terminals and conductors for the electricity supply of the led.

In a further advantageous embodiment of the led lamp system according to the invention, in the recess in the body of the holder electronic components are accommodated that are electrically connected to the electric wiring for the electricity supply of led(s). In case that these electronic components comprise a dimmer circuit that is connected to a temperature sensor, it is possible to operate the lamp system with a maximum power and therefore maximum resulting amount of light in relation to the dimensions and cooling possibilities. When the temperature exceeds a predetermined threshold value, then the dimmer circuit is dimming the led so that the heat generated is reduced. In addition to the temperature sensor and the dimmer circuit, also a control circuitry is provided that when the signal of the temperature sensor exceeds the threshold value, it controls the dimmer. In case the electronic components comprise a circuit for changing the polarity of a voltage, it is no longer necessary to make arrangements such that the supply voltage is provided with the right polarity to the leds, because this circuitry then corrects a possible wrong polarity in the voltage supply.

In again a further advantageous embodiment of the led lamp system according to the invention, the holder and fitting, when they are mutually attached, comprise at least for a part of their surfaces, conforming and mutually contacting surfaces. This then promotes the heat transport from the holder to the fitting, and when the fitting is mainly comprising a material with good heat conducting properties, the cooling of the leds is being further facilitated.

The heat transfer of the holder to the fitting, and thus the cooling of the leds, is further increased when the heat expansion coefficient of the holder is larger than the heat expansion coefficient of the fitting. Then the contact between the holder and fitting, and therefore the heat transport between these, will increase with increasing temperature.

In a preferred embodiment of the invention, the holder and the fitting are shaped and dimensioned in such a way that the holder exclusively fits a fitting according to the invention and that in the fitting exclusively a holder according to the invention can be fitted. Because of this it is impossible that in a fitting according to the invention, that is arranged for receiving a led lamp according to the invention, a lamp of an other kind is being inserted. A lamp of an other kind could damage the transformer, which supplies the electric power for the led lamp. Also by such an embodiment of the holder it can be prevented that the led lamp according to the invention is being inserted in a fitting that is not arranged for a led lamp, which in a very short time or even immediately could damage the led lamp beyond repair.

In a preferred embodiment the fitting comprises a fitting housing of a mainly cylindrical external shape, wherein the diameter of the cylinder lies in the range between 26-28 mm, or in the range from 38-40 mm or in the range from 50-54 mm, wherein the fitting housing, at the end that is facing away from the attachment position of the holder, is provided with an opening with an internal thread and M10x1. These dimensions are near to usual dimensions of fittings and for the installation of the led lamp system according to the invention in armatures it is of advantage when the external dimensions of the fittings will comply with the standard dimensions in the lighting industry. An opening with an internal thread M10x1 is also very common in the lighting industry.

In a very advantageous embodiment of the invention the fitting and holder are executed with a known system for the mutual attachment, such as an Edison thread, wherein at the location of the Edison thread the external diameter of the holder and the internal diameter of the fitting deviate more than 1 mm from 14 mm as well as from 27 as well as from 40 mm. Because of this the fitting according to the invention will not be able to receive other lamps with an Edison thread and neither a led lamp according to the invention will fit in another fitting than a fitting according to the invention. Another favourable possibility for mutual attachment of fitting and holder is by means of a bayonet system, either of the type BA or of the type GU. Both types are known in the lighting industry. An advantageous way to prevent that the fitting according to the invention will not be able to accommodate other lamps with a bayonet attachment of the type BA or GU and neither a led lamp according to the invention will fit in an other fitting than a fitting according to the invention, is achieved when the cylinder wall of the holder and the cylinder wall of the fitting have a diameter that deviates at least 1 mm, however preferably at least 2 mm from dimensions that are common in the lighting industry for other lamps than lamps according to the invention. In an other embodiment this is being achieved when the fitting at an internal cylindrical surface, that is meant for receiving the external cylindrical surface of the holder, is provided with a protrusion and the external cylindrical surface of the holder comprises a groove for receiving the protrusion during attachment of the holder to the fitting, or vice versa.

Versatility of use of the led lamp system according to the invention is further increased by providing the holder at the side of the led with a thread for attaching an end-piece that is at least partly transparent. This transparent end-piece can for example be shaped as a light bulb, a cube, a block, a tube, a sphere or like a candle flame. With this the looks of different kinds of lamps can be simulated in a led lamp system. Moreover by a suitable choice of the colour of the end-piece, the colour of the emitted light can be influenced.

The external appearance of a led light according to the invention can be further embellished by providing the holder with an ornament that is located in the light beam emitted by the led, wherein the ornament for example has the shape of a filament, a reflecting sphere, reflecting star or a reflecting cube.

The invention will now be further explained following a description of certain embodiments of the invention, referring to the drawing in which:

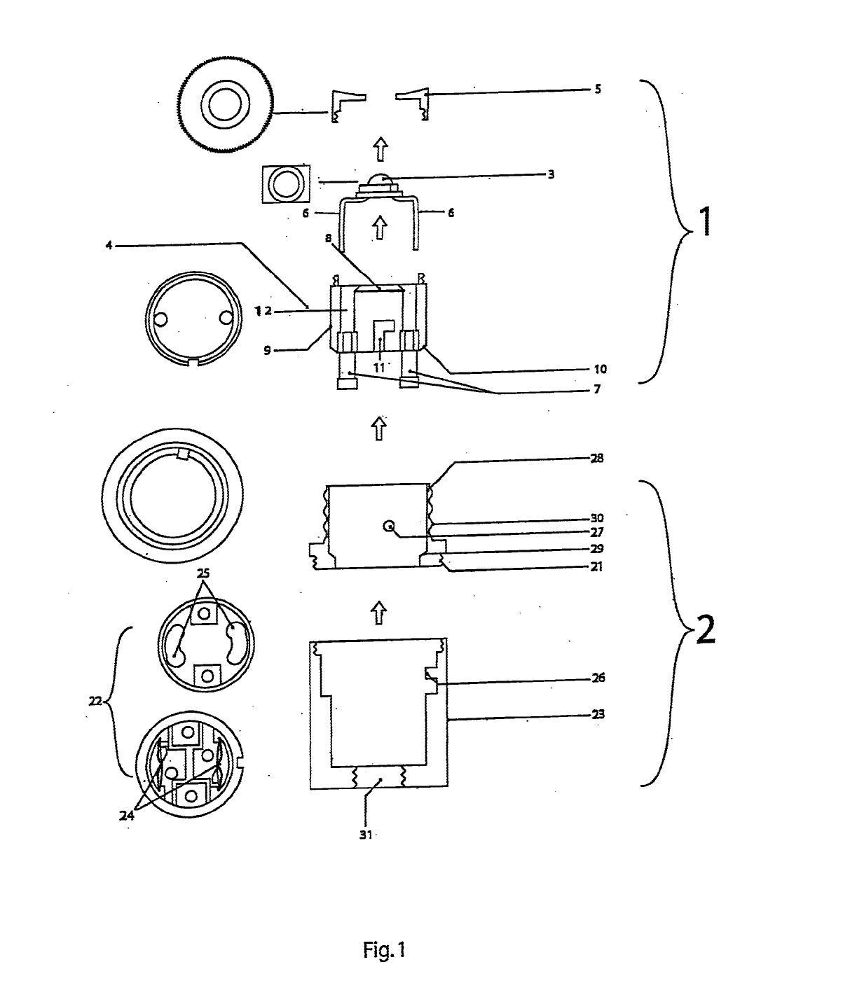

FIG. 1 shows an exploded view of an example of an embodiment of an led lamp system according to the invention;

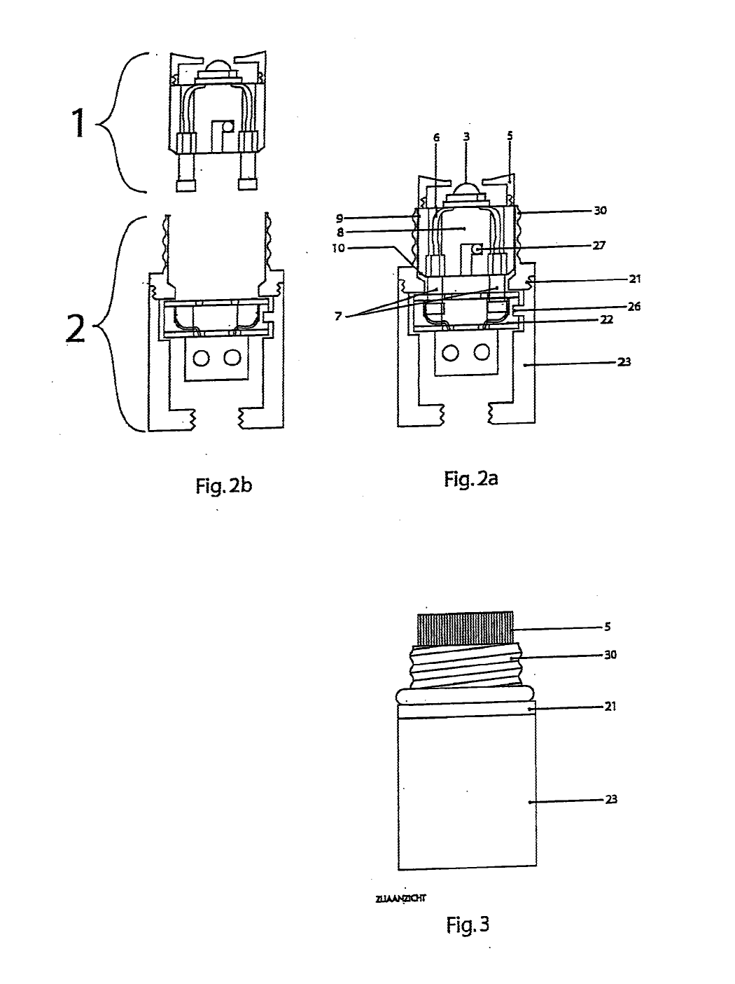

FIG. 2a shows a cross section of the lamp system according to FIG. 1 in assembled condition;

FIG. 2b shows led lamp and fitting of the led lamp system of FIG. 2a above each other;

FIG. 3 shows a side elevation view of the lamp system according to FIG. 2;

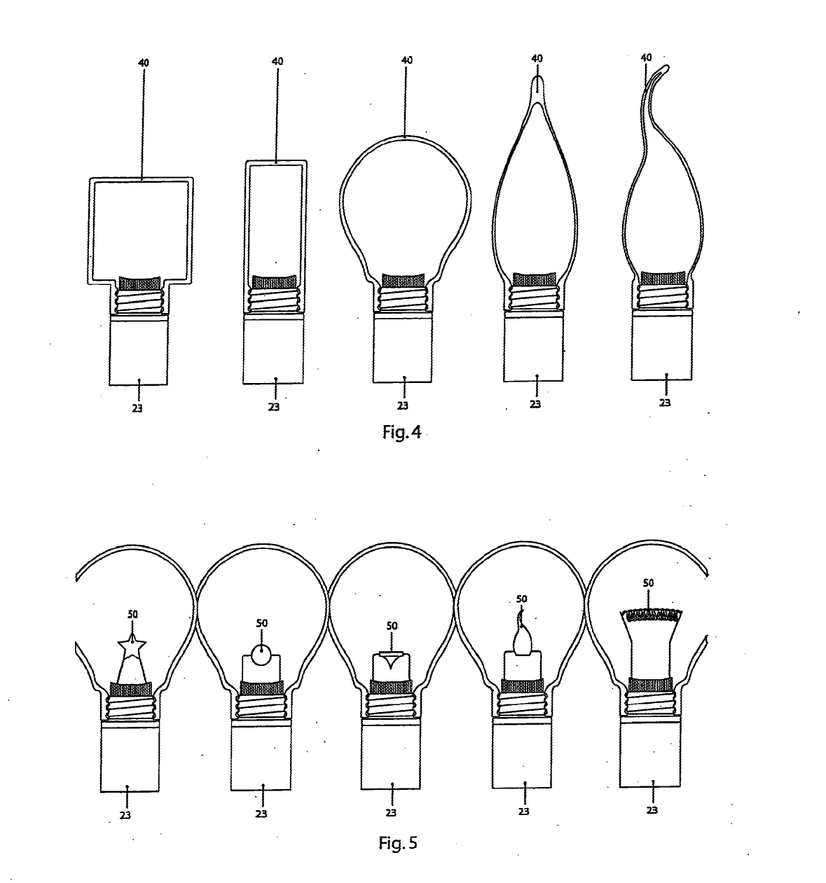

FIG. 4 shows examples of embodiments of a led lamp system according to the invention provided with an end-piece;

FIG. 5 shows examples of embodiments of a led lamp system according to the invention provided with an end-piece and an ornament;

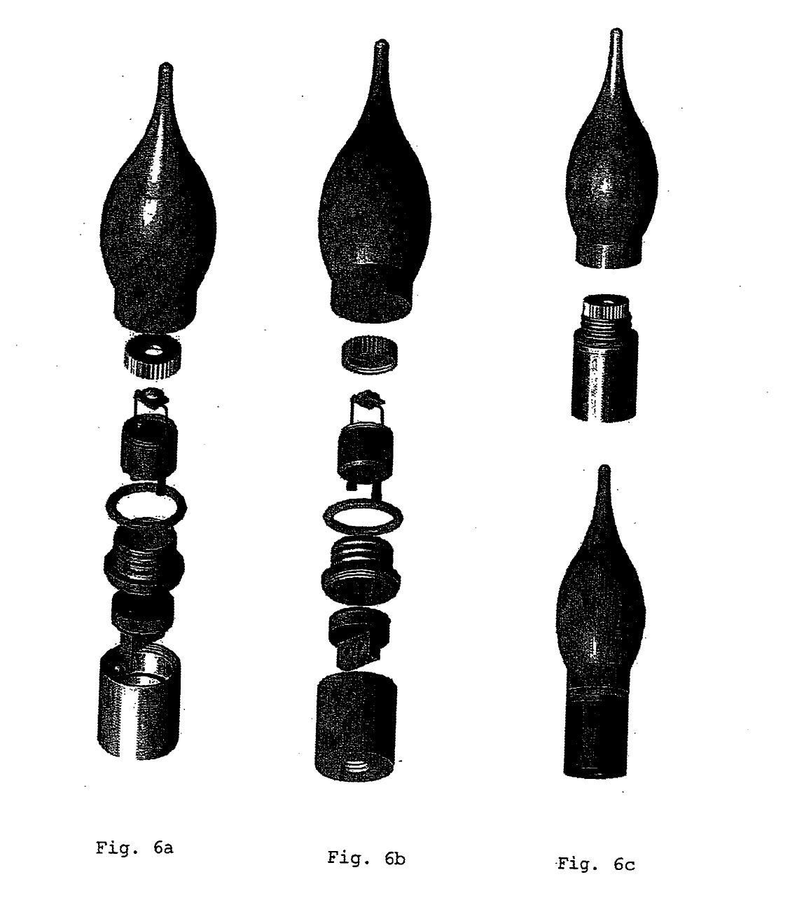

FIGS. 6a, 6b and 6c show a exploded view in perspective of the embodiment of a led lamp system according to FIG. 1 with an end-piece in a view from the front and above, in a view from the front and below and in assembled condition of the end-piece above fitting with lamp as screwed on the fitting, respectively;

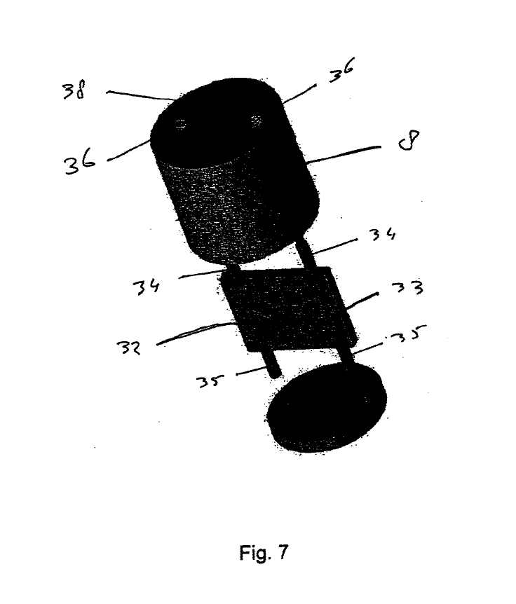

FIG. 7 shows a detail of an embodiment of a holder according to the invention; and

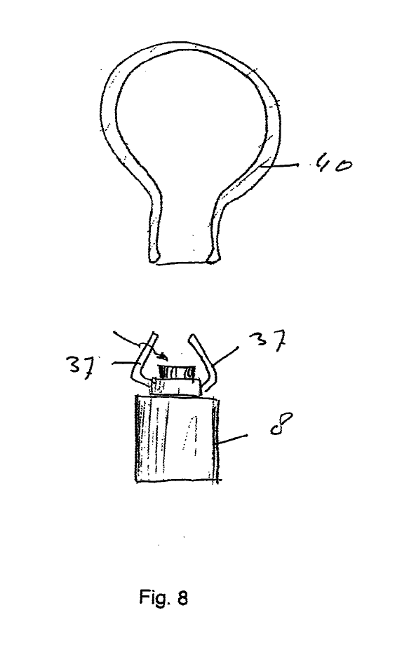

FIG. 8 shows an example of a led lamp system according to the invention with an end-piece.

FIG. 1 shows an exploded view of an example of an embodiment of a led lamp system according to the invention and FIG. 2a shows a cross section of the lamp system according to FIG. 1 in assembled condition, with a led lamp, that as a whole is indicated with 1 and a corresponding fitting that is indicated with 2. For clarity FIG. 2b shows led lamp 1 and fitting 2 in cross section above each other. Led lamp 1 comprises led 3, holder 4 and cap 5. The led lamp system according to the invention does not comprise a transformer and needs thus to be supplied with a supply of electricity that is prepared for direct connection with led 3. Led 3 is retained by screwing cap 5 on holder 4. Led 5 comprises electrical connections 6, that are in conducting connection with contact legs 7 of holder 4. Holder 4 further comprises a thick walled aluminium body 8, with a cylindrical outer wall 9, with a bevelled underside 10.

Between the electrical connections 6, the conducting connection and the contact legs 7 on the one hand and the body 8 on the other hand, an electrical insulation has been disposed that is not specifically indicated in the drawing.

Another embodiment of a holder body 8 is being displayed in FIG. 7. A thick walled cylindrical holder body 8 is shown with at one end also a thick walled end-surface 38 on which led 3 is being attached, led 3 is not shown in FIG. 7. In an internal recess in holder body 8 a circuit board 32 with electronic components can be accommodated, of which the insulating edges 33 are fitting in grooves that are disposed in the internal recess in holder body 8. Also visible in FIG. 7 are insulated electrical supply leads 35 to the board 32 and insulated electrical supply leads 34 from the board 32 to led 3. In end-face 38 openings 36 are provided for the passage of leads 34. From practical experiments as well as from calculations with thermal models it appears that for a holder body from aluminium with a diameter and a length of approximately 18 mm a wall-thickness of 2 mm provides sufficient heat dissipation.

Led lamp 1 and fitting 2 can be connected to each other by means of a GU bayonet connection. A GU bayonet connection is a common connection in the lighting industry between a lamp and a fitting. With such a fitting it is very simple to replace a lamp and this can be done without tooling by any consumer with few movements of a hand.

Fitting 2 comprises a fitting sleeve 21, connection bushing 22 and fitting house 23. In FIG. 1 the top plate of bushing 22 is shown separately, disconnected from bushing 22, so that also from above the electrical contacts 24 are visible, which are meant to make contact with the contact legs 7 of led lamp 1. In the top plate of bushing 22 also openings 25 are visible through which in a usual way for a GU bayonet fitting contact legs 7 can be entered and can be fixed by a slight rotation. Bushing 22 is clamped in its position by screwing sleeve 21 on fitting house 23. Fitting house 23 further comprises a protrusion 26, that fits in a groove in the side wall of bushing 22, which groove is not displayed here.

During mounting of led lamp 1 and fitting 2, led lamp 1 is slid in sleeve 21 of fitting 2, so that contact legs 7 can enter through the wide part of openings 25, after which by a small rotation of lamp 1, contact legs 7 get in contact with contacts 24 and also become clamped in the smaller part of openings 25. To this cylindrical outer wall 9 and bevelled end 10 get in contact with the cylindrical inner wall 28 and accompanying bevelled part 29 of fitting sleeve 21. Through this contact not only the position of lamp 1 in relation to fitting 2 has kept stationary in a stable way, but also via the thick walled aluminium body 8 a good heat conduction is created from led 3 to the external surface of sleeve 21, and via this also with the external surface of the fitting house 23, so that the heat can be dissipated via a large surface. Because of this the temperature of led 3 in use is decreased considerably, which has a positive influence on the life of the led.

Further it is visible in FIG. 1 that on the inner wall 28 of fitting sleeve 21 a protrusion 27 is formed and in the outer wall 9 of holder 4 a groove 11 is formed. Protrusion 27 and groove 11 are complementary in shape so that during attachment of led lamp 1 in fitting 2, protrusion 27 is situated in groove 11. Through this led lamp 1 can only be attached in one way in fitting 2 and consequently contact legs 7 are contacting contacts 24 of the fitting in a unique way. Through this the right polarity of the electricity supply of led 3 can be assured. Also protrusion 27 and groove 11 guarantee that led lamp 1 cannot be attached in another fitting than a fitting according to the invention and also in a fitting according to the invention no other lamp can be attached than a led lamp according to the invention. This prevents costly mistakes that can damage led lamp 1 or a transformer.

Finally fitting house 23 comprises at the bottom side an opening 31 in which a thread M10x1 has been formed, through which fitting 2 can be attached to an armature in a simple and usual way.

In the example of an embodiment of a led lamp system according to the invention as described before, an example has been shown with a GU bayonet coupling between led lamp 1 and fitting 2. It will be clear that in a similar way a led lamp system can be executed with another coupling between led lamp and fitting, such as an Edison thread or a BA bayonet coupling.

When the described fitting 2 according to the invention has been mounted in an armature, it is for a user possible to make a choice from a spread of different led lamps 1 according to the invention in a very simple way and in such a way the user can compose the desired lighting with regards to clarity and colour and is in that way not dependant of the choice of a supplier of the armature.

In FIG. 1 and FIG. 2 can also been seen that on the outside 30 of the fitting sleeve 21 a thread has been disposed. On this thread an end-piece 40 can screwed of which in FIG. 4 different embodiments have been shown. End-piece 40 is for example from transparent glass or frosted glass. Also end-pieces are possible that are completely or partly transparent or reflecting. Through this the possibility of the user to arrange the lighting to his wishes is further increased. In FIG. 8 a different embodiment is shown of an attachment of an end-piece 40. This attachment uses a number of clamps 37 that are distributed over a circumference and engage flexibly in the inside of the end-piece 40.

By exchangeable led lamps according to the invention it is attractive for a user when the spread of choice from different led lamps 1 is further enlarged. This is for instance possible by fitting out led lamps 1 with different ornaments 50, of which examples have been shown in FIG. 5. These ornaments 50 are located in the light beam of led 3, so that during use of led lamp 1 the ornament is illuminated. Ornament 50 can have different shapes and is preferably strongly reflective.

To provide a total impression of an example of an embodiment of a led lamp system according to the invention, FIG. 6a shows an exploded view in perspective of the embodiment of a led lamp system according to FIG. 1 with an end-piece in a view from the front and from above. FIG. 6b shows the image of FIG. 6a in a view from the front and from below, while in FIG. 6c the assembled situation is shown of both the end-piece above the fitting with lamp, as the end-piece screwed on the fitting. Between end-piece and fitting an elastic plastic ring is visible that has not been discussed before, that fulfils the usual function of relatively soft part at the junction of two hard and thus vulnerable parts in their mutual contact.

Some embodiments have been described of the invention. This description only serves for clarification and not for limitation of the invention as described in the claims.

### LIST OF REFERENCE NUMBERS

1 Led lamp
2 Fitting
3 Led
4 Holder
5 Cap
6 Electrical leads of led
7 Contact legs
8 Thickwalled heat conducted body of holder
9 Cylindrical outer wall of holder
10 Bevel of 4
11 Groove
12 Recess in 8
13 Electronic components
21 Fitting sleeve
22 Connection bushing
23 Fitting housing
24 Electrical contacts of 22
25 Openings of 22
26 Protrusion of 23
27 Protrusion of 21
28 Cylindrical inner wall of 21
29 Bevel of 21
30 Outside of 21 with thread
31 Opening in 23
32 Circuit board with electronic components
33 Insulated edges of 32
34 Insulated electrical leads
35 Insulated electrical leads
36 Openings in 38
37 Flexible clamps for 40
38 End-surface of 8
40 End-piece on 21
50 Ornament

1. Led lamp system with a led lamp (1) and a fitting (2), wherein:
the led lamp (1) comprises at least one led (3) with connected to the at least one led leads (6) for electricity supply to the led (3), and a holder (4) with electrical terminals (7), wherein the at least one led (3) is connected to the holder (4) and the leads (6) that are connected to the at least one led (3), are connected to the electrical terminals (7) of the holder (4) I an electrically conducting way,
the fitting (2) and holder (4) are detachably be attached to each other,
the fitting (2) is equipped with electrical connections (24) for receiving electricity supply that is suitable for the led (3), and that cooperate in attached condition with terminals (7) at holder (4), characterized in that he holder (2) is arranged for heat conduction and arranged for transport of heat from led (3) to an external surface (9) of the holder (4).

2. Led lamp system according to claim 1, characterized in that the holder (4) comprises a essentially thick-walled cylindrical body (8) with a thick-walled end-surface from a material with good heat conducting properties and comprises at least one recess (12) for the electrical leads (6), wherein the led (3) is mounted at the end-surface of the cylindrical body (8).

3. Led lamp system according to claim 2, characterized in that in the recess (12) electrical components (13) are accommodated, that are connected with the electrical leads (6).

4. Led lamp system according to claim 3, characterized in that the electrical components (13) comprise a dimmer circuit that is connected to a temperature sensor.

5. Led lamp system according to one of the claims 3 and 4, characterized in that the electrical components (13) comprise a circuit for switching the polarity of a voltage.

6. Led lamp system according to one of the claims 1 to 5, characterized in that the holder (4) and fitting (2) at least for a part of their surfaces comprise mainly conforming surfaces and that the fitting (2) mainly is made of a material with good heat conducting properties.

7. Led lamp system according to claim 6, characterized in that the thermal expansion coefficient of the holder (4) is larger than the thermal extension coefficient of the fitting (2).

8. Led lamp system according to one of the claims 1 to 7, characterized in that the holder (4) and the fitting (2) are shaped and dimensioned such that the holder (4) exclusively fits in a fitting (2) according to the invention and that in fitting (2) exclusively a holder (4) according to the invention can be fitted.

9. Led lamp system according to one of the claims 1 to 8, characterized in that the fitting (2) comprises a fitting housing (23) with a mainly cylindrical external shape, wherein the diameter of the cylinder is in the range from 26-28 mm, or in the range from 38-40 mm or in the range from 50-54 mm.

10. Led lamp system according to one of the claims 1 to 9, characterized in that the fitting housing (23) at the end facing away from the attachment location of the holder (4) comprises an opening (31) with an internal thread M10x1.

11. Led lamp system according to one of the claims 1-10, characterized in that the mutual attachment of holder (4) and fitting (2) is by means of Edison thread.

12. Led lamp system according to claim 11, characterized in that at the location of the Edison thread the external diameter of the holder (4) and the internal diameter of the fitting (2) differ more than 1 mm from 14 mm as well as from 27 mm as well as from 40 mm.

13. Led lamp system according to one of the claims 1 to 10, characterized in that the mutual attachment of holder (4) and fitting (2) takes place by means of a bayonet system from the type chosen from the group consisting of type BA and type GU.

14. Led lamp system according to claim 13, characterized in that the cylinder wall (9) from holder (4) and the cylinder wall (28) from the fitting (2) have a diameter that deviates at least 1 mm, however preferably at least 2 mm from the dimensions that are standard in the lighting industry for lamps other than lamps (1) according to the invention.

15. Led lamp system according to claim 13, characterized in that one from an internal cylindrical surface (28) of the fitting (2) and an external cylindrical surface (9) of the holder (4) comprises a protrusion (27)
and the other of the internal cylindrical surface (28) of the fitting (2) and the external cylindrical surface of the holder (4) comprises a groove (11), in which the protrusion (27) is received at attachment of the holder (4) to the fitting (2).

16. Led lamp system according to one of the claims 1 to 15, characterized in that the fitting (2) at the side of the led (3) comprises a thread (30) for attaching an end-piece (40) that is at least partly transparent.

17. Led lamp system according to one of the claims 1 to 15, characterized in that the fitting (2) at the side of the led (3) comprises flexible clamps (37) spread over a circumference for attachment of a end-piece (40) that is at least partly transparent.

18. Led lamp system according to claim 16 or 17, characterized in that the end-piece (40) has a shape that is chosen from the group comprising: a light bulb, a cube, a block, a tube, a sphere or a candle flame.

19. Led lamp system according to one of the claims 1 to 18, characterized in that the led lamp (1) comprises an ornament (50) that is located in a beam that is emitted by the led (3).

20. Led lamp system according to claim 19, characterized in that the ornament (50) has a shape that is chosen from the group consisting of: a filament, a reflecting sphere, a reflecting star and a reflecting cube.

21. Led lamp (1) according to one of the claims 1 to 20.
